(19) United States
(12) Patent Application Publication
(10) Pub. No.: US 2003/0163778 A1
(43) Pub. Date: Aug. 28, 2003

(54) System and method for improved validation for claims compliance

(76) Inventors: Michelle Shores, Atlanta, GA (US); Dave Rice, Ellicott City, MD (US); Tim Beyer, St. James, NY (US); Robert M. Payne, Pelham, AL (US); Farley Kamhi, Brooklyn, NY (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/085,376

(22) Filed: Feb. 28, 2002

(51) Int. Cl. G06F 17/21

(52) U.S. Cl. 715/500; 715/505

(57) ABSTRACT

A system and method for providing a limited number of special edits to claims during electronic document exchange to facilitate claims compliance. A limited number of fields in each claim file are defined as key fields which have data corresponding to stored verification data. Files having incomplete or inaccurate data in any field are identified as errored claims. The claims identified as having errors in the key fields are automatically edited by exchanging the incomplete or inaccurate data for the stored verification data. The fields of a claim other than those defined as key fields are precluded from being automatically edited. By limiting the number of key fields to be automatically edited, the number of edits are controlled to expedite the validation process and to preclude false claims compliance.

### TECHNICAL FIELD

The present invention relates to the translation and validation of electronic data and, more particularly, relates to locating and editing of errored claims.

### BACKGROUND OF THE INVENTION

Electronic Data Interchange (EDI) is the electronic exchange of business transactions from one company's computer to another company's computer in computer-processable data formats without human intervention. Several different data formats can be utilized to transmit data between different EDI systems connected to a network.

For example, hospitals store a wealth of information on each patient, health care provider and medical intervention occurring within their facilities. The hospitals then transmit portions of this information to health care insurers to get reimbursement for health care costs. The information requesting reimbursement for health care provided to a patient typically is transferred to the health care insurer in the form of a claim. The exact format of a claim takes many different electronic forms depending on the entity that generated the claim. In addition, some claims pass through third party claim clearing houses before being accepted by the health care insurer which may further change their electronic format. Payment obligations may pass to claims clearinghouses, other insurers, or a financial institution. The data transfer itself may occur through very different transfer protocols and data error detection process resulting in transforming data into even other different formats.

EDI software translates documents into recognizable standard formats and routes the data through the EDI clearinghouse. The clearinghouse makes it possible to bundle all of a user's transmissions into a single transmission. Some clearinghouses audit the documents they receive. Typically, the clearinghouse simply rejects or accepts the claims without modifying the claims they audit. Some rejected claims are reported back to the user or are rejected. However, some users pay for special edits to errored claims in order to get paid more quickly and accurately. These special edits consist of personnel opening an errored claim one at a time. A special edit mode must be entered before locating the data field with the error. Once the data field with the error is located, the correct data is entered by hand if it is known. This sequence of editing claims by hand is repeated for each file having an error.

One problem with this known method of special edits of errored claims is that there are numerous data fields which may contain incorrect data and often the correct data to be entered is not known. Simply, it is practically impossible for a claims editor to correctly edit a large amount of claims when the correct data is either not available or unknown. Thus, these known special edits often result in unwanted abnormalities in claims which cause the incorrectly edited claims to be rejected.

Therefore, there is a need for improved claims editing to expedite processing of transactions and eliminate false claims compliance. This system must permit special editing of multiple claims at onetime with increased accuracy.

### SUMMARY OF THE INVENTION

The present invention provides a customized application-specific interface to customers, while utilizing the suppliers' existing infrastructure so that the suppliers never have to translate application or system specific files while transmitting or receiving files. The present invention solves the above-identified problem by providing automated special edits on a limited number of specific fields of multiple files at the same time.

Generally described, the present invention includes a system and method for providing electronic document exchange between trading partners associated with an electronic data processing system. The present invention transmits files in a first file format from one of the trading partners to a computer system. Each of the files have a plurality of fields for data entry. A limited number of fields in each file are defined as key fields which have data corresponding to stored verification data accessible by the computer system. At least a portion of the files received in the first file format are mapped into a second file format to be received by another of the trading partners.

Files having incomplete or inaccurate data in any field are identified as errored claims. The claims identified as having errors in the key fields are automatically edited by exchanging the incomplete or inaccurate data for the stored verification data. The trading partners receiving data in the second file format are free of performing application or system specific translations or claim modifications.

In one aspect of the present invention, the key fields of a claim are the fields defined for receiving a member number, a provider number, a procedure designation, and a date of service. The fields of a claim other than those defined as key fields are precluded from being automatically edited by exchanging the incomplete or inaccurate data for the stored verification data. By limiting the number of key fields, the number of edits are controlled to expedite the validation process and to preclude false claims compliance.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 illustrates one embodiment of an electronic data management system of the present invention for performing electronic data interchange between trading partners.

FIG. 2 illustrates one embodiment of a flow chart depicting the steps performed by the data management system of FIG. 1 to edit errored claims.

### DETAILED DESCRIPTION

The present invention provides a system and method for improved validation for claims compliance. The present invention provides automated special edits of claims between trading partners to facilitate the claim validation process.

The foregoing exemplary embodiments may be conveniently implemented in one or more program modules as well as hardware components. The present invention may conveniently be implemented in a traditional programming language such as COBOL, “C”, etc., or may be implemented using a new programming language developed for practicing the present invention. However, no particular programming language has been indicated for carrying out the various tasks described because it is considered that the operation, steps, and procedures described in the specification and illustrated in the accompanying drawings are sufficiently disclosed to permit one of ordinary skill in the art to practice the instant invention.

Moreover, in view of the many different types of computers, computer platforms and program modules that can be used to practice the present invention, it is not practical to provide a representative example of a computer program that would be applicable to these many different systems. Each user of a particular platform would be aware of the language and tools which are more useful for that user's needs and purposes to implement the instant invention.

In addition, a software program implementing an embodiment of the present invention may run as a stand-along program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

In one embodiment of the present invention, trading partners 100 access a public network 102 such as the Internet via their existing Internet Service Provider, and EDI claims management software 110 sends and receives documents in a defined data format across the network 102. The EDI claims management software 110 runs on computer equipped with a modem and communications software to provide dial-up access to the network 102. The common format for Web-based document exchanges is the HyperText Markup Language (HTML). A company's HTML-based forms are converted behind a web site into EDI- formatted messages before being passed on to the recipient. The trading partners can communicate with one another via the Internet's File Transfer Protocol, commonly referred to as FTP. Alternatively, other technologies such as the HTTP protocol of the Web can be used for uploading and downloading files.

Each trading partner 100 has a computer connected to each other over the data network 102. Each computer generally consisting of a processing unit which interfaces to a memory storage device, a display device and a user input device. Access to the network is provided through an interface device. The interface device supports at least one access line connecting to the computer to the network 102. The access line may consist of analog or digital interfaces, and supports the process of transmitting and receiving analog or digital data in real-time or otherwise.

The memory storage device is operative to store a program module for implementing an exemplary embodiment of the present invention. For example, the present invention implemented as a computer program running on the computer, provides an interface to a user via the display device. The processing unit is responsive to instructions of the program module. In general, the program module can transport data over the access line into the interface device.

Each computer is in communication with a coordinating network server that is designated for the exchange of information over the network. The network 102 is designed to communicate with computers at different locations that all read from the common coordinating network server. Periodic updates are used system-wide to provide current information to all locations on the network 102 and to maintain system integrity. Update frequency is determined based on system demands.

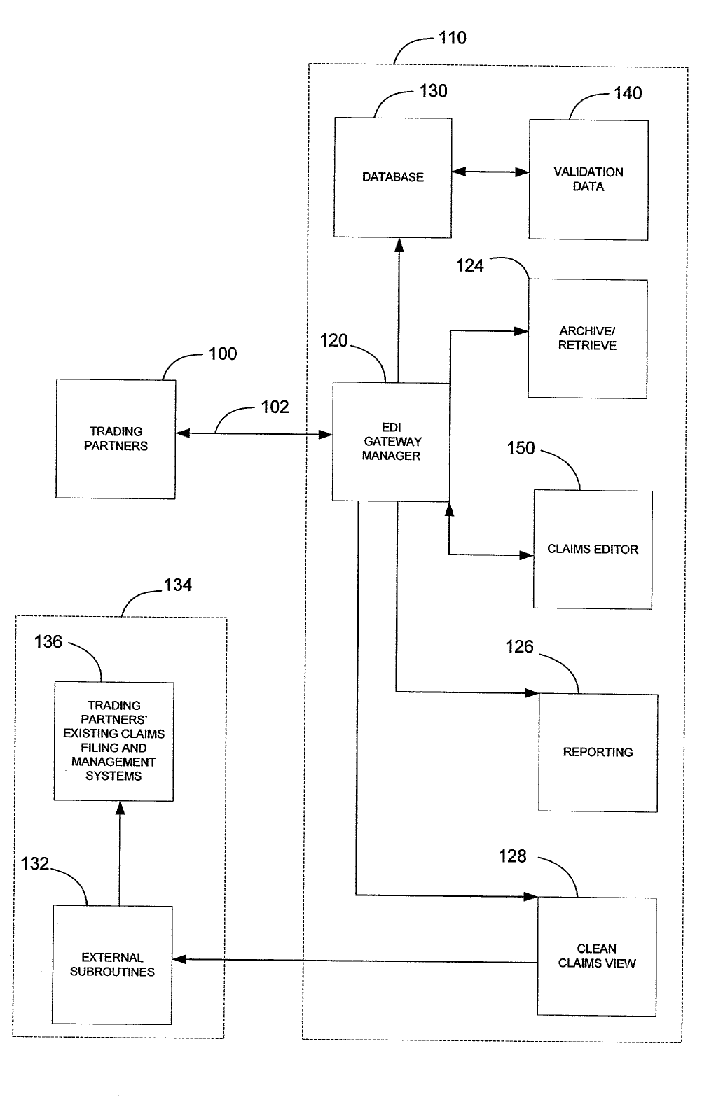

In one embodiment, the present invention includes an EDI gateway manager 120 and a database 130. The EDI gateway manager 120 uploads and downloads data to and from the network server and performs the batch transfer and claims validation functions. As shown in FIG. 1, the EDI gateway manager 120 organizes and retrieves files as shown in block 124. The EDI gateway manager 120 also provides the reports as shown in block 126 to provide activity summaries, error reports and audit logs, as well as views of the claims as depicted by block 128. External subroutines 132 of a trading partner's 100 existing system 134 may be accessed by the EDI gateway manager 120 of the claims management system 110. From these existing subroutines 132, external pricing is available as well as additional validation checks. As shown in FIG. 1, valid claims implemented from the clean views may be uploaded to a trading partner's existing electronic claims filing and management system such as ClaimsPro® as shown in block 136.

The database 130 is created and managed by a database program or database management system (DBMS). The DBMS includes a database engine for storing and retrieving data. Alternatively, the database engine may be self-contained. The DBMS can manage any form of data. In the preferred embodiment of the present invention, the DBMS allows for management of data structured as fields, records and files. Therefore, the file structure of the database 130 is determined by the software needed to manage the data.

In an alternative embodiment, the database 130 may be a database server on the network 102 that is dedicated to database storage and retrieval. The database server and the network server may be one in the same if it performs central storage for applications and files as well as database services. The database server holds the DBMS and the database 130. Upon request, the database server searches the database 130 for selected records or pages and passes them over the network 102.

Each field of a record is defined by name, type and length which allows separation of the data in the claims. However, in the present invention, one or more of the fields is defined as a key field. The key fields are the fields on which the databases of the present invention are maintained. The database 130 linked to the key fields to provide common data to allow for matching is updated whenever new records are added or existing records are deleted or any data eligible for a key field changes. Although a one-to-many relationship between a key field and the database 130 has been disclosed above, the present invention also includes a one-to-one relationship between the key fields and the database 130. In the preferred embodiment, the database 130 of the present invention provides the data validation. However, the EDI gateway manager may also provide some data validation in the manner of the present invention.

For example, in the healthcare industry, the key fields correspond to the member number, the provider number, the procedure code and the date of service. Therefore, validations tables 140 which correspond with the member number, the provider number, the procedure code and the date of service are maintained on the database 130. Preferably, the validation tables 140 and updates are provided by the trading partners. Although a larger number of key fields may be designated, only a limited number of key fields are preferred to facilitate the present invention. The validation tables may be viewed and edited.

The claims are processed in batch mode to automate the process. Preferably, the server processes the received files and formats the data to the specifications for distribution among the trading partners according to a predefined format and schedule. Prior to importing a batch of claims, a map is defined. The mapping performed in the present invention is routing performed in typical network operations where logical associations are made of one set of values to another set of related values stored in memory or on disk. EDI claims management systems include translator engines that provide the EDI mapping. The user selects an input file and a map file such that the incoming claim files are associated with a claim mapping file to place the claims in a desired format. For example, incoming medical claims received in a particular local format are structured according to a standard national format. However, it is also within the scope of the present invention to receive data in a standard format and then push it out in a non-standard format.

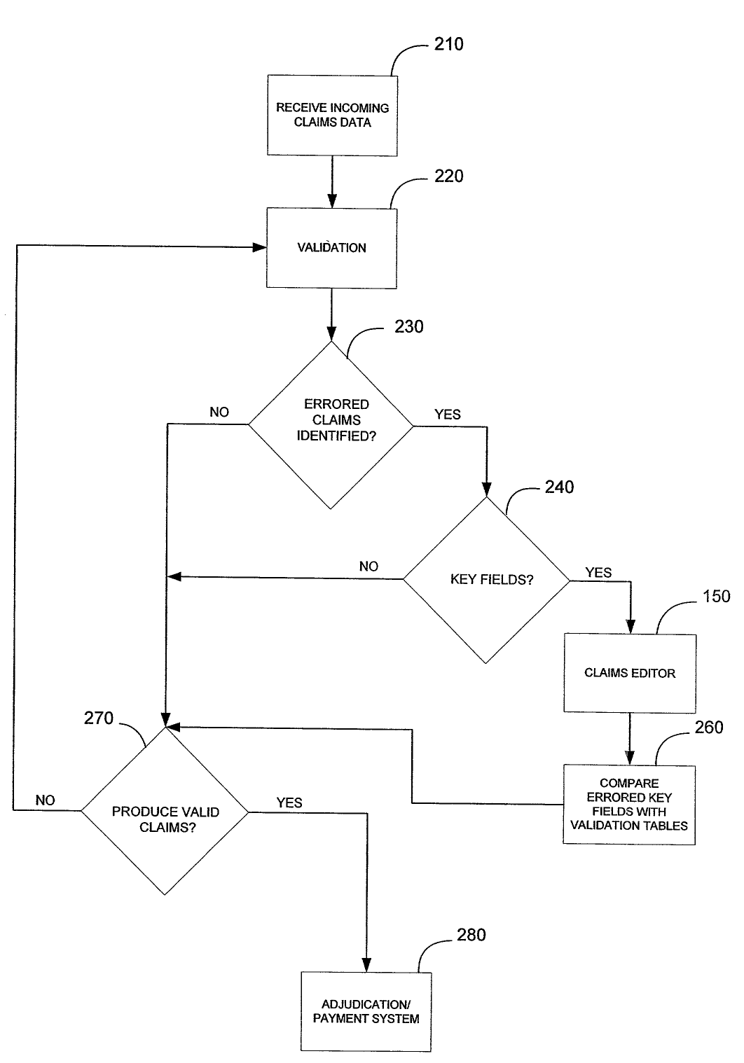

FIG. 2 illustrates a flow chart of one embodiment of the steps for editing errored claims according to the present invention. During the batch transfer, the EDI gateway manager 120 receives the incoming claim information and places it in the database 130 as shown process block 210. Then, during the validation process, shown by block 220, the incorrect or incomplete claims are mapped to the validation tables so that the EDI gateway manager 120 can inspect the claims for the correct data. If the data is located and is correct, the processed claim files are placed back in the database 130. If the data is incorrect or incomplete, the files with incorrect or incomplete data are suspended and flagged as errored claims.

In FIG. 2, an inquiry is conducted at decision block 230 to determine if any processed claims have been identified as errored claims. In response to having identified errored claims, the YES branch is followed to a subsequent inquiry at decision block 240. If key fields in the errored claims include incorrect or incomplete data, the YES branch is followed to process block 150 depicting activation of a claims editor.

As shown in FIG. 1, the EDI gateway manager 120 of the present invention includes a claims editor 150 running as a stand-alone program or software module, routine or function call, operating in conjunction with the EDI gateway manager 120. The claims editor 150 of the present invention allows for viewing and editing of the suspended claims. However, the editing of the errored claim is preferably limited to where the claims did not pass validation for one or more of the key fields. In the preferred embodiment, the editing of errored claims is limited to the provider ID, the member ID, the procedure code and/or the date of service fields.

Referring now to FIG. 2, the claims editor 150 compares errored key fields with the validation data 140 to replace or insert the correct data. Although each of the key fields may be examined, only the key fields with inaccurate or incomplete data are edited. For example, if it is determined that a claim includes invalid member and provider numbers, the claims editor 150 goes into the errored claim and substitutes the incorrect data with the correct data from the validation tables. However, in some instances, all of the key fields may be edited. Once the errored claims have been scrubbed, the process continues to inquiry block 270 to determine whether valid claims have been produced. In some instances, inquiry block 240, described above, may be skipped and the process would then proceed along the NO branch from inquiry block 230 directly to inquiry block 270.

If clean claims have failed to be produced, the NO branch of inquiry block 270 would return to the validation block 220. The NO branch from inquiry block 70 may be repeated followed as part of a continuous loop to implement continued validation until clean claims have been produced. Once valid claims are available, and if the user no longer desires to continue editing operations, the YES branch from inquiry block 270 is followed to process block 280 depicting the activation of the adjudication and payment systems, where the user exits the EDI gateway manager 120 and the claims editor 150.

The present invention has been illustrated in relation to particular embodiments which are intended in all respects to be illustrative rather than restrictive. Those skilled in the art will recognize that the present invention is capable of many modifications and variations without departing from the scope of the invention. Accordingly, the scope of the present invention is described by the claims appended hereto and supported by the foregoing.

What is claimed is:

1. A computer-implemented method for providing electronic document exchange between a plurality of trading partners, each trading partner associated with an electronic data processing system connected to a communications link and a computer system, said method comprising the steps of:
transmitting a plurality of files, each having a plurality of fields for data entry, in a first file format from one of the trading partners to one of said computer systems;
defining a portion of said fields of each said file as key fields having data corresponding to stored verification data accessible by said computer system;
mapping at least a portion of said files received in said first file form, at into a second file format to be received by another of the trading partners wherein said first file format is unique from said second file format;
identifying files as errored claims as a result of having incomplete or inaccurate data in any of said fields; and
automatically editing only said key fields of said errored claims by exchanging said incomplete or inaccurate data for said stored verification data.

2. The method of claim 2 wherein the trading partners receiving data in said second file format are free of performing application or system specific translations.

3. The method of claim 1 wherein said key fields are defined for receiving a member number, a provider number, a procedure designation, and a date of service.

4. The method of claim 3 wherein said key fields are precluded from being otherwise defined.

5. The method of claim 1 wherein said errored claims having said incomplete or inaccurate data in other than said key fields is left unedited.

6. The method of claim 1 further comprising the step of providing a list of errors in each file identified as being an errored claim.

7. The method of claim 6 further comprising the step of manually editing said errored claim based upon said list of errors provided for identifying errors in each said file.

8. The method of claim 1 wherein said first file format is a non-standard file format and said second file format is a standard file format.

9. The method of claim 1 wherein said first file format is a standard file format and said second file format is a non-standard file format.

10. The method of claim 1 wherein said first file format is a non-proprietary file format and said second file format is a proprietary file format.

11. The method of claim 1 wherein said first file format is a proprietary file format and said second file format is a non-proprietary file format.

12. The method of claim 1 further comprising the step of accessing the Internet to transmit and receive data.

13. The method of claim 12 further comprising the step of reformatting said data off-line.

14. An electronic forms processing system on a network of computers, said computers transmitting data between one another, at least one of said computers receiving information in a first file format and at least another of said computers transmitting and receiving information in a second file format, said electronic forms processing system having an electronic forms editor program module, said editor program module comprising instructions which, when executed by at least one of said computers, performs the steps of:
transmitting a plurality of files, each having a plurality of fields for data entry, in a first file format from one of the trading partners to one of said computer systems;
defining a portion of said fields of each said file as key fields having data corresponding to stored verification data accessible by said computer system;
mapping at least a portion of said files received in said first file format into a second file format to be received by another of the trading partners wherein said first file format is unique from said second file format;
identifying files as errored claims as a result of having incomplete or inaccurate data in any of said fields; and
automatically editing only said key fields of said errored claims by exchanging said incomplete or inaccurate data for said stored verification data.

15. A computer-implemented method for providing electronic document exchange between a plurality of trading partners, each trading partner associated with an electronic data processing system connected to a communications link and a computer system, said method comprising the steps of:
transmitting a plurality of files, each having a plurality of fields for data entry, in a first file format from one of the trading partners to one of said computer systems;
defining a portion of said fields of each said file as key fields having data corresponding to stored verification data accessible by said computer system, said key fields defined for receiving a member number, a provider number, a procedure designation, and a date of service;
mapping at least a portion of said files received in said first file format into a second file format to be received by another of the trading partners wherein said first file format is unique from said second file format;
during said mapping step, identifying files in said second data format as errored claims as a result of having incomplete or inaccurate data in any of said fields;
automatically editing only said key fields of said errored claims by exchanging said incomplete or inaccurate data for said stored verification data, wherein the trading partners receiving data in said second file format are free of performing application or system specific translations.

16. A computer readable storage medium on which is stored a computer program for use with a centralized computer system utilized by a plurality of trading partners to facilitate management of electronic documents, said program comprising instructions which, when executed by a computer, perform the steps of:
transmitting a plurality of files, each having a plurality of fields for data entry, in a first file format from one of the trading partners to one of said computer systems;
defining a portion of said fields of each said file as key fields having data corresponding to stored verification data accessible by said computer system;
mapping at least a portion of said files received in said first file format into a second file format to be received by another of the trading partners wherein said first file format is unique from said second file format;
identifying files as errored claims as a result of having incomplete or inaccurate data in any of said fields; and
automatically editing only said key fields of said errored claims by exchanging said incomplete or inaccurate data for said stored verification data.
